(19) United States
(12) Patent Application Publication
(10) Pub. No.: US 2012/0185440 A1
(43) Pub. Date: Jul. 19, 2012

(54) METHOD AND APPARATUS FOR PROVIDING ADDRESS BOOK RESTORATION

(75) Inventors: Thinh Nguyenphu, Southlake, TX (US); Claude Kawa, Montreal (CA)

(73) Assignee: NOKIA SIEMENS NETWORKS OY, Espoo (FI)

(21) Appl. No.: 13/393,237

(22) PCT Filed: Aug. 13, 2010
(86) PCT No.: PCT/EP10/61834

§ 371 Date: Mar. 26, 2012

Related U.S. Application Data
(60) Provisional application No. 61/238,501, filed on Aug. 31, 2009.

(51) Int. Cl. G06F 17/30

(52) U.S. Cl. 707/674; 707/E17.005

(57) ABSTRACT

An apparatus for providing address book restoration includes at least one processor and at least one memory including computer program code. The at least one memory and the computer program code are configured to, with the at least one processor, cause the apparatus to receive an instruction to restore a record associated with a contact previously deleted from each of at least two synchronized address books, and recover the record from a deleted file repository at which the record was stored prior to deletion of the record, the deleted file repository being a memory location different than the address books. A corresponding method and computer program product are also provided.

### TECHNOLOGICAL FIELD

Embodiments of the present invention relate generally to data synchronization technology and, more particularly, relate to a method and apparatus for providing address book restoration following deletion of information in a synchronized address book.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. One area in which there is a demand to increase ease of information transfer relates to the synchronization of content on multiple devices. In this regard, given the ability for modern electronic devices to create and modify content, and also to distribute or share content, it is not uncommon for multiple copies of a particular content item to be stored at respective different locations within a network. In some cases, it may be desirable to ensure that the various different files or copies of a particular content item remain updated or synchronized with respect to each other. Accordingly, synchronization techniques have been developed to provide for data synchronization.

Numerous different protocols have been developed to handle synchronization. Some of these protocols allow only changed files to be synchronized instead of synchronizing all files on devices being synchronized. SyncML and ActiveSync are examples of such protocols. In order to accomplish some types of synchronization, files at one device (e.g., the serving device) may be mapped to files at the other device (e.g., the client device), for example, by linking identifiers of the files on both devices to each other. This enables, for each identified file, an indication to be provided as to whether the file has been changed and should therefore be synchronized. If a file requires synchronization, an updated copy of the file to be synchronized may be transferred from one device to the other.

The synchronization of client and server devices is not only useful for updating changes to existing files. Instead, new files on either the client or the server may also be duplicated to the other device during synchronization. Additionally, synchronization of client and server devices can also be accomplished in relation to deletion of content. In this regard, for example, if the client device deletes a particular content item and later synchronizes the database of the deleted content item with the server device, the server device will also delete the content item during the next synchronization event in order to provide synchronization between the corresponding databases of the client and server devices.

The synchronization activities described above may also apply to certain applications such as distributed client-server applications. For example, a phone book, address book or other contact list is an example of a distributed client-server application in which data can be stored at, and synchronized between, two communicating devices (e.g., the client and the server). In this regard, the client (e.g., a mobile telephone, laptop computer or other mobile or remote terminal) and the server (e.g., a server device or other computer such as a PC (personal computer)) may interact to ensure that they are “in sync” or synchronized with respect to having the same contact information. However, because the devices will by nature synchronize with each other, if a particular contact is deleted, any backup for the contact information associated with that contact will also be deleted during the next synchronization event and it may be difficult or inconvenient to replace a deleted contact.

### BRIEF SUMMARY

Some embodiments of the present invention may provide a mechanism by which deleted contact information that is deleted from each of two communicating devices (e.g., a client and server device) in response to synchronization of such devices may be recoverable. As such, for example, some embodiments may provide for the employment of a contact waste basket to store deleted contact information in order to permit recovery of the deleted contact information.

In one exemplary embodiment, a method of providing address book restoration is provided. The method includes receiving an instruction to restore a record associated with a contact previously deleted from each of at least two synchronized address books, and recovering the record from a deleted file repository at which the record was stored prior to deletion of the record, the deleted file repository being a memory location different than the address books.

In another exemplary embodiment, a computer program product for providing address book restoration is provided. The computer program product may include at least one computer-readable storage medium having computer-executable program code instructions stored therein. The computer-executable program code instructions may include program code instructions for receiving an instruction to restore a record associated with a contact previously deleted from each of at least two synchronized address books, and recovering the record from a deleted file repository at which the record was stored prior to deletion of the record, the deleted file repository being a memory location different than the address books.

In another exemplary embodiment, an apparatus for providing address book restoration is provided. The apparatus includes at least one processor and at least one memory including computer program code. The at least one memory and the computer program code are configured to, with the at least one processor, cause the apparatus to receive an instruction to restore a record associated with a contact previously deleted from each of at least two synchronized address books, and recover the record from a deleted file repository at which the record was stored prior to deletion of the record, the deleted file repository being a memory location different than the address books.

Embodiments of the invention may provide a method, apparatus and computer program product for employment in systems where synchronization of data between a client device and a server is desired. As a result, for example, a mobile terminal and other electronic device may benefit from an ability to recover contact information for deleted contacts even after backup information has been deleted due to synchronization of the mobile terminal or other electronic device with its corresponding server.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 is a schematic block diagram illustrating one example of a communication system according to an exemplary embodiment of the present invention;

FIG. 2 illustrates a schematic block diagram of an apparatus for providing address book restoration according to an exemplary embodiment of the present invention;

FIG. 3 illustrates a communication flow diagram showing deletion and restoration of a contact according to an exemplary embodiment of the present invention;

FIG. 4 illustrates a communication flow diagram showing deletion and restoration of a contact according to an alternative exemplary embodiment of the present invention;

FIG. 5 illustrates an example showing delete and restore operations in accordance with an exemplary embodiment in which the contact waste basket is implemented in the client device instead of the server device; and

FIG. 6 is a flowchart according to another exemplary method for providing address book restoration according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

Embodiments of the present invention will be described in relation to an address book. However, it should be understood that the address book is merely one example of a context in which embodiments of the present invention may be practiced. Moreover, an address book should be understood to be an example of a contact list (e.g. a phone book) including information identifying one or more contacts and providing corresponding characteristics or contact information about each contact. As such, a “contact” may be understood to correspond to an address book entry including an identity (e.g., name, nickname, job title, alias, etc.) and other characteristics or contact information corresponding to the person or entity identified by the identity of the contact. The contact information may include street address, phone number, email address, web address, or other information relating to enabling or facilitating communication with the corresponding contact. The contact information or characteristics may also include biographical information or other notes regarding the corresponding contact. Each contact may also have one or more identifiers associated therewith. An identifier may provide a mechanism by which the corresponding contact is identifiable in the protocol used for synchronization. As such, for example, if SyncML/DS (SyncML data synchronization) protocol formatting is used, the identifier may provide a mechanism by which to identify a corresponding contact for SyncML/DS commands or messages.

As indicated above, synchronization of data has become more important with the proliferation of electronic devices that are capable of generating, modifying and/or consuming content. Thus, content may be created, copied, modified and distributed, in some cases even in various versions. In some instances, users desire for the same content to be accessible via different devices. For example, a user may personally own multiple devices (e.g., a media player, a mobile telephone, a laptop computer or PC, and/or others) via which the user would like to be able to access particular content. Alternatively, the user may wish to share the particular content with users of other devices of friends (e.g., in a social network setting) or colleagues (e.g., in a corporate or enterprise network setting). In such situations, it may be desirable for any changes made to the particular content at one device to be synchronized with versions of the particular content that may be stored at the other devices or at a location (e.g., a central location such as a server) accessible to the other devices. Thus, for example, a user who receives contact information for a particular contact may enter the contact information in a mobile telephone. However, the user may desire for that information to also be accessible via the user's laptop or PC. The user may also desire for network backup of the contact information. As such, the user may synchronize the mobile telephone with a network server to backup the new contact information at the server. The server (or the mobile telephone) may then synchronize with the laptop or PC to provide the new contact information to the laptop or PC as well.

For many services in which provision of the service involves a two way communication of data between devices, data synchronization between the devices may be desirable at periodic intervals. For example, in the case of email services, an email server may synchronize periodically with a remote device such as a laptop computer or a mobile terminal directly or by providing data for synchronization to a synchronization server. Similarly, with a network address book (sometimes referred to as a converged address book (CAB)) that comprises a distributed client-server application, contact information stored on a client device may be duplicated by synchronization with a server. Thus, updates to contact information, additional contacts and contact deletions that are implemented at a mobile terminal acting as a client device may be synchronized with a server to ensure that both the client and the server have the same contact information.

In some cases, a wired or wireless communication network may be utilized to initiate a communication session between the server and the remote device during which data synchronization may be accomplished, for example, at either regular intervals or in response to receipt of new data or changes to data. During the data synchronization, the remote device may communicate changes such as a deleted contact to the server and the server may delete the corresponding contact stored at the server. Having been deleted at both the remote device and the server, the deleted contact is normally not recoverable. However, embodiments of the present invention may provide a mechanism by which the deleted contact may still be recovered.

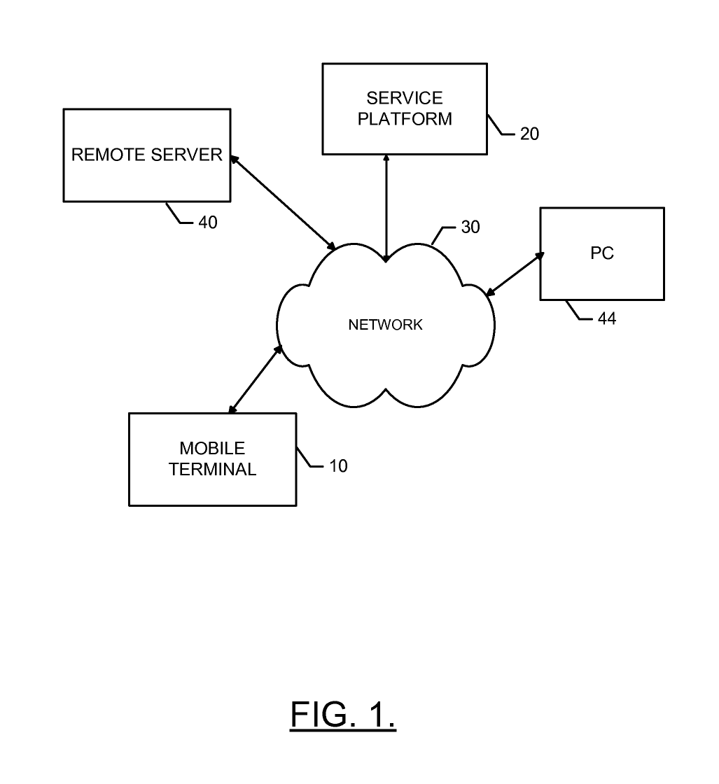

FIG. 1 illustrates a block diagram of a system that may benefit from embodiments of the present invention. It should be understood, however, that the system as illustrated and hereinafter described is merely illustrative of one system that may benefit from embodiments of the present invention and, therefore, should not be taken to limit the scope of embodiments of the present invention. As shown in FIG. 1, an embodiment of a system in accordance with an example embodiment of the present invention may include a mobile terminal 10 capable of communication with numerous other devices including, for example, a service platform 20 via a network 30. In some embodiments of the present invention, the system may further include one or more additional devices such as personal computers (PCs), servers, network hard disks, file storage servers, and/or the like (e.g., remote server 40, PC 44, and others), that are capable of communication with the mobile terminal 10 and accessible by the service platform 20. However, not all systems that employ embodiments of the present invention may comprise all the devices illustrated and/or described herein.

The mobile terminal 10 may be any of multiple types of mobile communication and/or computing devices such as, for example, portable digital assistants (PDAs), pagers, mobile televisions, mobile telephones, gaming devices, laptop computers, cameras, camera phones, video recorders, audio/video player, radio, global positioning system (GPS) devices, or any combination of the aforementioned, and other types of voice and text communications systems, can readily employ embodiments of the present invention.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), e.g., the Internet. In turn, other devices such as processing elements (e.g., personal computers, server computers or the like) may be included in or coupled to the network 30. By directly or indirectly connecting the mobile terminal 10 and the other devices (e.g., service platform 20, remote server 40, PC 44, etc.) to the network 30, the mobile terminal 10 and/or the other devices may be enabled to communicate with each other, for example, according to numerous communication protocols including Hypertext Transfer Protocol (HTTP) and/or the like, to thereby carry out various communication or other functions of the mobile terminal 10 and the other devices, respectively. As such, the mobile terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

In an example embodiment, the service platform 20 may be a device or node such as a server or other processing element. The service platform 20 may have any number of functions or associations with various services. As such, for example, the service platform 20 may be a platform such as a dedicated server (or server bank) associated with a particular information source or service, or the service platform 20 may be a backend server associated with one or more other functions or services. As such, the service platform 20 represents a potential host for a plurality of different services or information sources. In some embodiments, the functionality of the service platform 20 is provided by hardware and/or software components configured to operate in accordance with known techniques for the provision of information to users of communication devices. However, at least some of the functionality provided by the service platform 20 may be data processing and/or service provision functionality provided in accordance with embodiments of the present invention. As such, for example, the service platform 20 may include a network address book configured to mirror the address book (e.g., via synchronization) of the address book of other devices (e.g., the mobile terminal 10 or the PC 44).

In some cases, the service platform 20 may represent a plurality of different services or information sources including, for example, a network address book application. As such, for example, other devices like the remote server 40 may be included within the service platform 20 in some cases. Indeed, the devices shown in FIG. 1 are provided merely to illustrate a few examples of the diversity of available devices that may employ embodiments of the present invention.

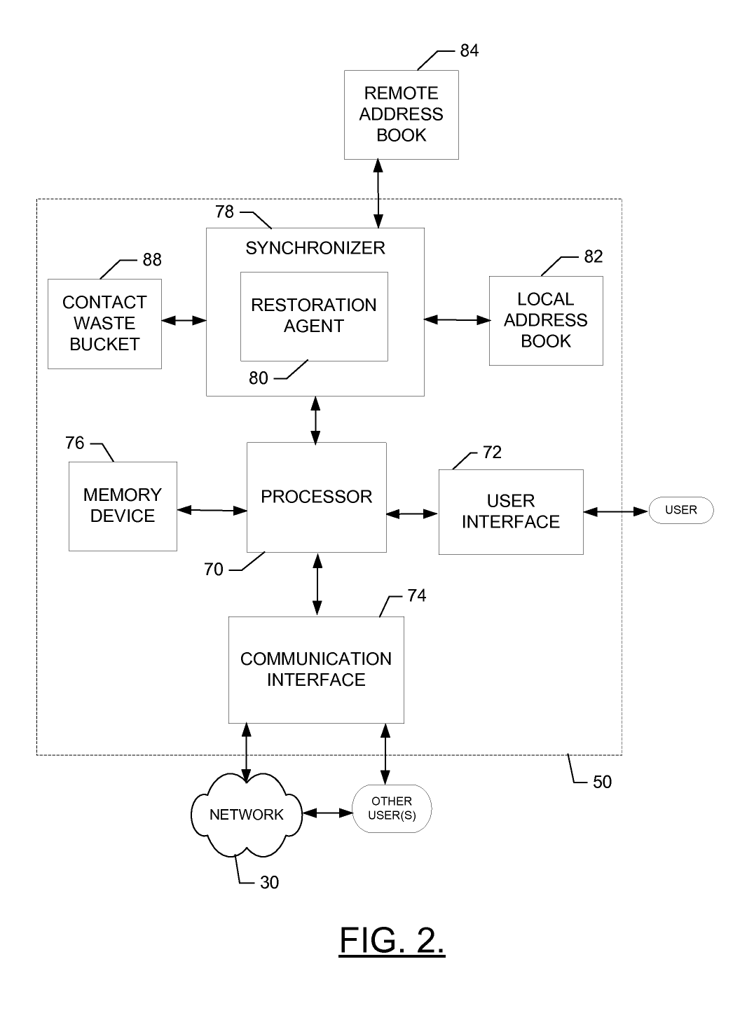

In an exemplary embodiment, an apparatus 50 is provided that may be employed at a device involved in performing synchronization according to exemplary embodiments of the present invention. The apparatus 50 may be employed, for example, by the mobile terminal 10 or PC 44 acting as a client device synchronizing with the remote server 40 or the service platform 20 acting as a serving device. However, embodiments may also be embodied on a plurality of other devices such that, for example, instances of the apparatus 50 (or portions of the apparatus 50) may be embodied on both client side and server side devices. Thus, the apparatus 50 will be described in generic terms so as to have broad application to either client side or server side devices, As such, the apparatus 50 of FIG. 2 is merely an example and may include more, or in some cases less, than the components shown in FIG. 2.

Referring now to FIG. 2, an apparatus for employing address book synchronization is provided. The apparatus 50 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device comprising logic gates, transistors and/or other memory cells configured to store data (e.g., bits) that may be retrievable by a machine (e.g., a computing device). The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases or storage locations that store information and/or media content (e.g., contact information associated with an address book).

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a hardware accelerator, a special-purpose computer chip, or the like. In an exemplary embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as Bluetooth, Infrared, UWB, WiFi, and/or the like, which are being increasingly employed in connection with providing home connectivity solutions.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an exemplary embodiment, the processor 70 may be embodied as, include or otherwise control a synchronizer 78 and a restoration agent 80. The synchronizer 78 and the restoration agent 80 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the synchronizer 78 and the restoration agent 80, respectively, as described herein. Thus, in examples in which software is employed, a device or circuitry (e.g., the processor 70 in one example) executing the software forms the structure associated with such means.

In some embodiments, the restoration agent 80 may be a portion of the synchronizer 78 (as shown in FIG. 2). However, in other examples, the restoration agent 80 and the synchronizer 78 may be separate devices or modules. In either case, the restoration agent 80 and the synchronizer 78 of exemplary embodiments of the present invention may provide for restoration of deleted items that have been deleted from a local address book 82 and a remote address book 84. The local address book 82 may represent a file or database associated with an address book application for storing contact information associated with one or more contacts locally at the apparatus 50. Meanwhile, the remote address book 84 may be a corresponding file or database associated with another address book application at another device remote from the apparatus 50. However, in some cases, the remote address book 84 could represent a remote address book of each of multiple other devices with which the apparatus 50 may be in communication and enabled to conduct synchronization operations. It should be noted that although the synchronizer 78 is shown in operable communication with the remote address book 84 in FIG. 2, such communication should be understood to be capable of occurring via the communication interface 74 and the network 30 and also with a remote device (or with a synchronizer of the remote device).

Since the apparatus 50, as indicated above, may be embodied at any number of devices (such as the mobile terminal 10, the service platform 20, the remote server 40 or the PC 44), the local address book 82 could be at any one of the devices listed above, while the remote address book 84 would then be disposed in at least one other one of the devices listed above. For example, if the apparatus 50 is embodied at the mobile terminal 10, the local address book 82 may be associated with the address book application or functionality of the mobile terminal 10 and the remote address book 84 may be associated with the service platform 20, the remote server 40 and/or the PC 44. Meanwhile, if the apparatus 50 is embodied at the service platform 20, the local address book 82 may be associated with the address book application or functionality of the service platform 20 and the remote address book 84 may be associated with the mobile terminal 10, the remote server 40 and/or the PC 44. Regardless, in some cases, the synchronizer 78 of the apparatus 50 may communicate with a synchronization engine or similar synchronizer of the remote device that hosts the remote address book 84.

The synchronizer 78, according to some embodiments, is configured to perform synchronization functions with respect to files of a device associated with the synchronizer 78. In this regard, for example, the synchronizer 78 of some examples is configured to generate and/or receive and process commands or instructions related to synchronization in accordance with a particular communication protocol. Thus, for example, the synchronizer 78 may be configured to process SyncML/DS commands to perform corresponding functions associated with each respective command. Moreover, the synchronizer 78 may receive user interface commands and/or indications of user activity (e.g., via the user interface 72) and issue corresponding commands (e.g., SyncML/DS commands) in order to execute functionality associated with the corresponding commands.

As such, for example, the synchronizer 78 may be configured to identify files to be synchronized (e.g., by identifying files for which differences exist between a file version at the apparatus 50 and a file version at another location, by identifying files that exist at the apparatus 50 and not at another location, by identifying files that exist at another location and not at the apparatus 50, and/or the like). In doing so, the synchronizer 78 may be configured to compare an identifier of a particular file of one device with identifiers of files at the other location(s) to determine if a file corresponding to the particular file exists at the other location and, if the file exists, determine whether differences exist between the particular file and the corresponding file. The synchronizer 78 may then issue commands in accordance with the applicable synchronization protocol to another device to copy information to the other device, move files, and/or to instruct deletion of information from the other device.

Alternatively or additionally, the synchronizer 78 may be configured to receive user input in the form of user interface commands or indications of user activity, and generate synchronization related commands based on the user input. The synchronization related commands may, as above, direct copying of information, movement of information and/or deletion of information in such a manner as to synchronize the apparatus 50 with another device. As an example, the user may select a hot key or a menu option associated with initiating synchronization and, in response to the user's activity, the synchronizer 78 may generate synchronization related commands to facilitate synchronization in accordance with exemplary embodiments of the present invention. Alternatively, the user input may simply be an action associated with deleting or creating new content (e.g., deleting a contact or creating a new contact) and the synchronizer 78 may generate synchronization related commands to facilitate synchronization either immediately in response to the activity or during the next synchronization event.

In some cases, rather than only generating synchronization related commands, the synchronizer 78 may simply respond to synchronization related commands generated elsewhere and received at the apparatus 50. The synchronizer 78 may therefore perform both generation and response functions with respect to synchronization related commands.

The restoration agent 80 may be configured to augment the synchronizer 78 in order to permit restoration of deleted items (e.g., deleted contacts) that have been deleted from both the local address book 82 and the remote address book 84. In particular, the restoration agent 80 may modify operation of the synchronizer 78 in relation to instances where a file is to be deleted and may also enable restoration of deleted files based on the modification made with respect to deleting files. In this regard, for example, in response to a user interface command input at the apparatus 50 to delete a file corresponding to a particular contact, the synchronizer 78 typically issues a command to delete a file associated with the particular contact (e.g., as identified by a corresponding identifier) from the local address book 82 and then generates a command to be sent to a remote device associated with the remote address book 84 to direct deletion of the corresponding file associated with the particular contact (e.g., as identified by the corresponding identifier) at the remote address book 84. The restoration agent 80 may operate to modify the above described communication in order to direct storage of a copy of the file associated with the particular contact at another location, referred to by way of example as a contact waste bucket 88 prior to or simultaneous with the deletion of the file. Generally speaking, the contact waste bucket 88 may be any storage location configured to act as a deleted file repository for storing files deleted from an address book.

Similarly, if instead of receiving a user interface command directing deletion of the file the apparatus 50 is synchronizing with the remote address book 84 and it is determined that a copy of the file associated with the particular contact has been deleted in the remote address book 84, the restoration agent may be configured to direct storage in the contact waste bucket 88 of the copy of the file associated with the particular contact that was stored in the local address book 82 prior to or simultaneous with the deletion of the file from the local address book 82 in order to facilitate synchronization of the remote address book 84 with the local address book 82.

Thus, in either case, a copy of the file may be stored in the contact waste bucket 88 while copies of the file are deleted from both the local address book 82 and the remote address book 84. Accordingly, although the particular contact is no longer present in either of the local address book 82 and the remote address book 84, information associated with the particular contact may be retrievable from the contact waste bucket 88. In particular, in response to a user interface command directing retrieval of a deleted contact (e.g., the particular contact), the restoration agent 80 may be configured to issue commands associated with retrieving the corresponding file and restoring the contact in the local address book 82 and/or the remote address book 84. If restored initially to only one of the local address book 82 or the remote address book 84, the contact may be restored to the other one of the local address book 82 or the remote address book 84 via a subsequent synchronization event. As such, for example, the file associated with the particular contact that was stored in the contact waste bucket 88 may be retrieved by the restoration agent 80 and provided to the local address book 82 and/or the remote address book 84.

Although shown to be included at the same location (e.g., at the apparatus 50) as the restoration agent 80 in FIG. 2, it should be appreciated that the contact waste bucket 88 may be a file, database or other storage location located at virtually any suitable location that is accessible to the restoration agent 80. Some embodiments of the present invention that provide implementation examples with various different architectures and command message structures are described below to illustrate the flexible nature of the solution described herein. However, it should be appreciated that the following examples are non-limiting and are instead provided by way of example only.

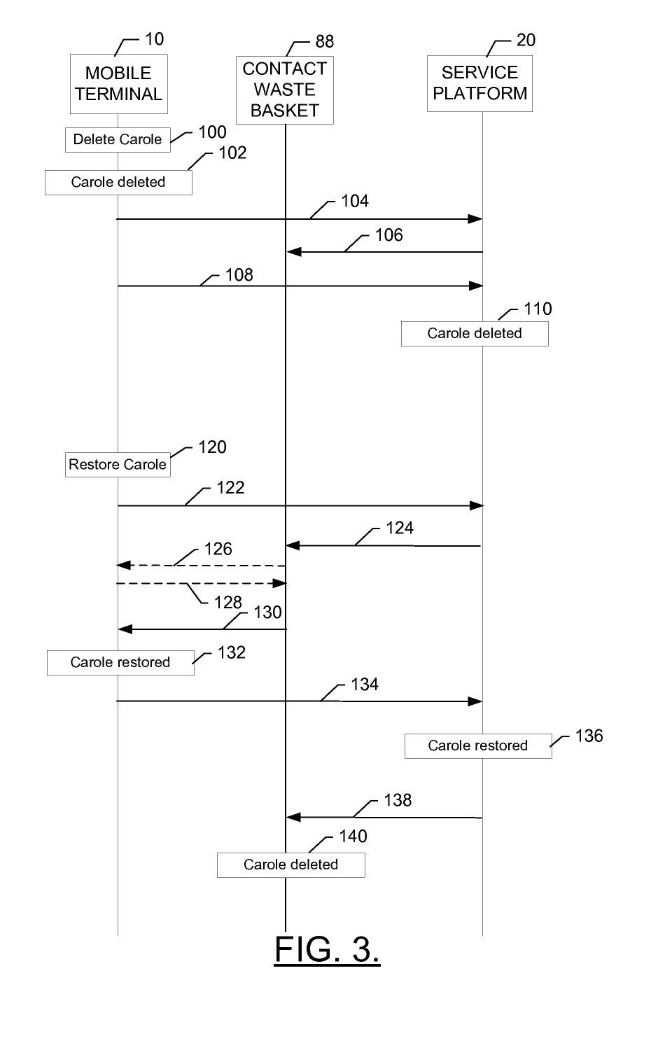

FIG. 3 illustrates a control flow diagram of synchronization involving a deleted contact and subsequent restoration of the deleted contact according to an exemplary embodiment. In this regard, FIG. 3 shows an example response to a user interface command received at a client device to delete a contact from a local address book of the client device. The client device of the present example is the mobile terminal 10 of FIG. 1. Thus, the local address book 82 of this example can be assumed to correspond to the address book of an application running at the mobile terminal 10. Meanwhile, the server device of this example may be assumed to be the server platform 20 so that the remote address book 84 may be the address book of an application running at the server platform 20. It should be noted that at least some of the communications shown in FIG. 3 may be provided via the synchronizer 78, the restoration agent 80 and/or the processor 70 of the apparatus 50 of FIG. 2 with respect to whichever of the mobile terminal 10 or the service platform 20 at which the apparatus 50 is resident for a particular example embodiment. Moreover, synchronization related commands and/or messages may be provided by SyncML/DS in this example, but other protocols may be employed in other embodiments.

Referring now to FIG. 3, an example in which the service platform 20 is enabled to provide a restoration function by controlling operation with respect to the contact waste bucket 88 is illustrated. In this example, the mobile terminal 10 may receive a user interface command directing deletion of a contact named Carole at operation 100. The mobile terminal 10 may delete its own copy of the file associated with Carole at operation 102 (e.g., in address book of the mobile terminal 10). The mobile terminal 10 may then provide an identifier (e.g., record ID=x) associated with Carole to the service platform 20 in a copy command (e.g., copy record ID=x from address book to contact waste basket) at operation 104. The file associated with Carole may then be copied from the address book of the service platform 20 to the contact waste basket 88 at operation 106. Of note, the contact waste basket 88 may be physically located within the memory of the service platform 20 in some examples. However, in alternative examples, the contact waste basket 88 may be located within a memory of another device which could even be a memory of the mobile terminal 10. After copying of the file associated with Carole to the contact waste basket 88, a command to delete the file associated with Carole may be provided at operation 108 (e.g., delete record ID=x from address book). In this regard, for example, the synchronization command provided may include a delete sub-command instructing the service platform 20 to delete record ID=x from its address book). At operation 110, the file associated with Carole may be deleted from the address book of the service platform 20.

As such, for example, a SyncML/DS command may be provided to a server (e.g., the remote server 40) of the service platform 20 directing the copying of the file associated with Carole to the contact waste basket 88 and then another command for deletion may be sent after the copying has occurred. However, in other cases, the performance of the copy operation may be automatically conducted by the server after synchronization with the mobile terminal 10 so there may be no need for an explicit copy message to be issued from the mobile terminal 10. In other words, in some cases, operation 104 may simply represent a synchronization command and the service platform 20 may automatically copy the file associated with Carole to the contact waste basket 88 at operation 106 without an explicit copying message. After operation 110, the address books of the mobile terminal 10 and the service platform 20 may be fully synchronized.

At some future time, an instruction may be provided by the user to restore the file associated with Carole as indicated by operation 120. In response to such instruction, the mobile terminal 10 may provide a restoration command to the service platform 20 directing restoration of the file associated with Carole at operation 122. In an exemplary embodiment, the restoration command may be a SyncML/DS command having an example form of “Get target=local-restored-address-book-records, source=address-book-waste-basket”. In the example form, the target may represent the local file on the device and the source may represent the file name on the server. In response to the restoration command, the service platform 20 may attempt to fetch the file associated with Carole from the contact waste basket 88 at operation 124. In some cases, such as when there are multiple files associated with Carole, a list of options from which the user may select is provided to the mobile terminal 10 at operation 126. A user selection of the desired file may then be provided at operation 128, if needed, in order to identify the file to be restored. Either in response to the selection of the desired file or in response to the fetch attempt if there is no need to select a file from a group of options, the file associated with Carole may be provided to the mobile terminal at operation 130. The file associated with Carole may then be restored at the mobile terminal 10 at operation 132. The mobile terminal 10 may then provide an instruction to the service platform to synchronize at operation 134. A sub-command of the instruction to synchronize may direct the service platform 20 to add a new record for Carole. Via synchronization with the mobile terminal 10, the file associated with Carole may also be restored at the service platform at operation 136.

In some embodiments, after the address books of the mobile terminal 10 and the service platform 20 are synchronized and the file associated with Carole is restored at both address books, the mobile terminal 10 may instruct the service platform 20 to delete the file associated with Carole at operation 138 that has been restored from the contact waste basket 88. In this regard, for example, the mobile terminal 10 may issue a command to delete record ID=x from address-book-waste-basket. However, in some embodiments, the service platform 20 may be configured to delete the file associated with Carole from the contact waste basket 88 without specific instructions from the mobile terminal 10. In either case, file deletion is shown at operation 140.

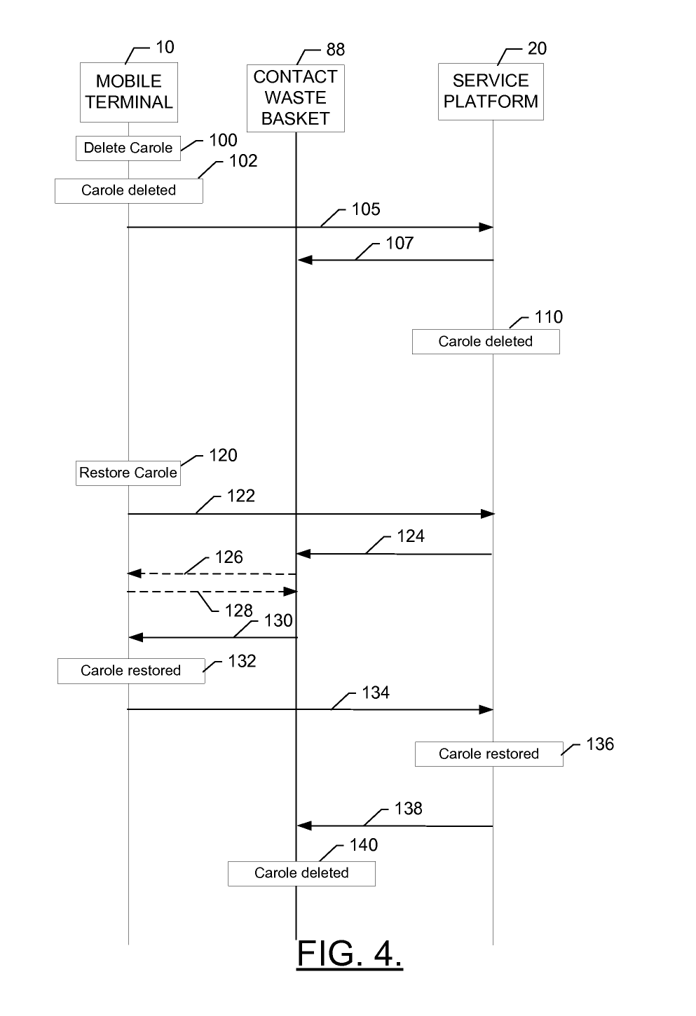

FIG. 4 illustrates an alternative to the example shown in FIG. 3 in which instead of using copy and delete functions, the mobile terminal 10 may implement a “move” function. In this regard, for example, the move function may provide for a file to be moved from an address book to the contact waste basket 88 without a separate copy and delete instruction. As an example, by providing an instruction Sync/Move record ID-x from waste basket to address book, the file associated with Carole will essentially be moved from the address book of the service platform 20 to the contact waste basket 88 and subsequently deleted from the address book of the service platform 20 automatically without separate copy and delete instructions. Accordingly, the operations of FIG. 4 are essentially identical to those of FIG. 3 except that operation 105 corresponds to a move command provided with respect to the file associated with Carole. Operation 107 then corresponds to the movement of the file associated with Carole to the contact waste basket 88, which results in the file associated with Carole being deleted from the service platform 20.

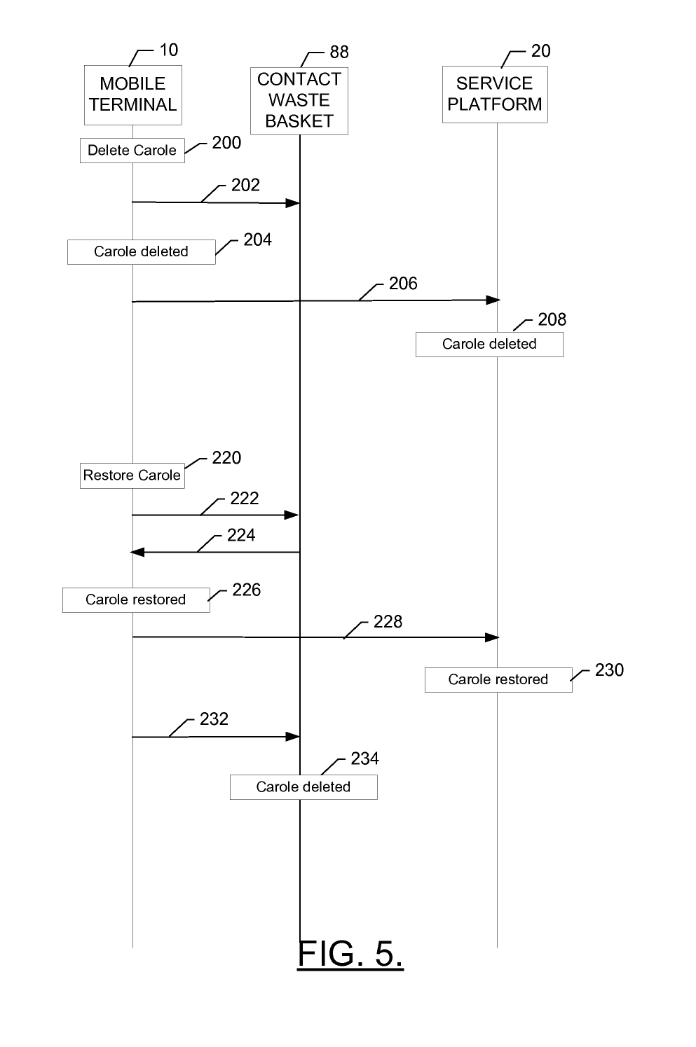

FIGS. 3 and 4 assume that the contact waste basket 88 is implemented at the service platform 20. However, the contact waste basket 88 could alternatively be implemented at the mobile terminal 10 (or any client device employing an embodiment of the present invention). FIG. 5 illustrates an example showing delete and restore operations in accordance with an exemplary embodiment in which the contact waste basket 88 is implemented in the client device instead of the server device.

Referring now to FIG. 5, the mobile terminal 10 may receive a user interface command directing deletion of the contact named Carole at operation 200. The mobile terminal 10 may copy its own copy of the file associated with Carole to the contact waste basket 88 at operation 202. After copying the file, the mobile terminal 10 may delete its own copy of the file associated with Carole at operation 204 (e.g., from the address book of the mobile terminal 10). The mobile terminal 10 may then (or at some later time) instruct synchronization with the service platform 20 at operation 206. The command to synchronize address books may include a sub-command to instruct the service platform 20 to delete the file associated with Carole (e.g., delete record ID=x from address book). In response to receipt of the command to delete the file associated with Carole, the service platform 20 may delete the corresponding file at operation 208. As a result of the operations described above, the address books of the mobile terminal 10 and the service platform 20 may each be synchronized and a copy of the file associated with Carole may be deleted from both, while having a copy still remaining in the contact waste basket 88.

At some future time, an instruction may be provided by the user to restore the file associated with Carole as indicated by operation 220. In response to such instruction, the mobile terminal 10 may retrieve the file associated with Carole at operation 222 and receive the retrieved file at operation 224. As described above in reference to the description of FIG. 3, when there are multiple files associated with Carole, a list of options from which the user may select is provided to the mobile terminal 10 and the user may select the desired file in order to identify the file to be restored. The file associated with Carole may then be restored in the address book of the mobile terminal 10 at operation 226.

After restoration of the file associated with Carole at the mobile terminal 10, the mobile terminal 10 may instruct synchronization with the service platform 20 at operation 228. The instruction to synchronize may include a sub-command instructing the service platform 20 to add a new record to its address book for the file associated with Carole. At operation 230, the file associated with Carole may be restored at the service platform 20.

In some embodiments, after the address books of the mobile terminal 10 and the service platform 20 are synchronized and the file associated with Carole is restored at both address books, the mobile terminal 10 may direct deletion of the file associated with Carole from the contact waste basket 88 at operation 232. The corresponding file may therefore be deleted at operation 234.

An alternative to the embodiments described above, each of which provides for full synchronization of the address books of the client device and the server device, may be to utilize a SyncML/DS “soft delete” function. By utilizing the so called soft delete function, a contact may be deleted from the address book of the client device, but may remain in the address book of the server device. This functionality may preserve the typically more limited resources of the client device for other uses, while only consuming resources of the server device, which may be expected to have very large resource capabilities and may therefore not be encumbered by the consumption of extra space for maintaining records not deleted from the address book of the server device.

In other alternatives, a web interface may be provided for retrieval of deleted records from a server side address book. In this regard, when the address book of the client device uses instructions (e.g., SyncML/DS instructions) to instruct the address book of the server device to delete an address book record or file associated with a particular contact, the server device saves the corresponding record or file to the contact waste basket 88 prior to deletion. Later on, the user can access an address book web page to request restoration of a deleted record that has been stored in the contact waste basket 88 to the server device. The server device may then synchronize with the client device in order to restore the record to the client device.

The web interface alternative may include web pages generated for the provision of the restoration function. Accordingly, in embodiments where a web interface is utilized, the restoration agent 80 may be configured to provide the corresponding web pages and functionality. However, in alternative embodiments, some other entity may provide access (e.g., HTTP access) and interface options either at the client side or at the server side, depending upon the design objectives of each individual design alternative.

Thus, according to some exemplary embodiments, an apparatus for providing address book restoration is provided. In this regard, by providing for storage of a copy of a record associated with a particular contact that is to be deleted within a contact waste basket, embodiments of the present invention enable restoration of a contact that has been deleted in each of a plurality of synchronizable address books. By exploiting storage of deleted records in a remote location, address books may be kept synchronized and unencumbered by resource consumption associated with storing undesirable contact information. However, if previously deleted contact information should become desirable at a later time, the contact information may be restored.

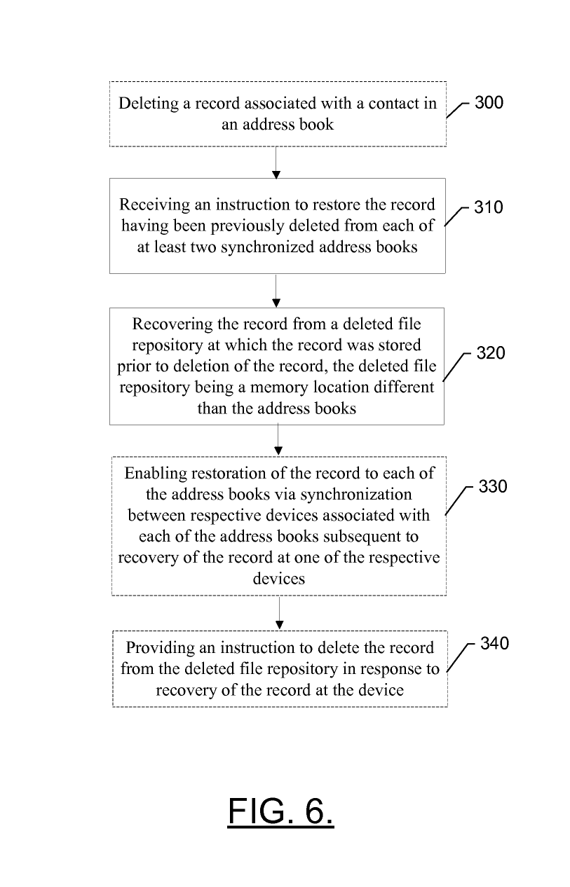

FIG. 6 is a flowchart of a system, method and program product according to exemplary embodiments of the invention. It will be understood that each block or step of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus embody means for implementing the functions specified in the flowchart block(s) or step(s). These computer program instructions may also be stored in an electronic computer-readable storage memory that may direct a computer or other programmable apparatus to function in a particular manner, such that the instructions stored in the computer-readable memory produce an article of manufacture the execution of which implements the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing address book restoration according to an exemplary embodiment, as shown in FIG. 6 includes receiving an instruction to restore a record associated with a contact previously deleted from each of at least two synchronized address books at operation 310 and recovering the record from a deleted file repository at which the record was stored prior to deletion of the record, the deleted file repository being a memory location different than the address books at operation 320.

In some embodiments, the method may include additional optional operations shown in dashed lines in FIG. 6. As such, for example, the method may further include deleting the record at operation 300. In some cases, operation 300 may include sub-operations or other activities such as, for example, providing a copy command to copy the record from one of the address books to the deleted file repository, and providing a delete command to delete the record from the one of the address books. As an alternative, operation 300 may include deleting the record at a local address book, providing an instruction to synchronize the local address book with a remote address book in response to which a corresponding record to the deleted record is automatically copied from a remote address book to the deleted file repository, and providing a delete command to delete the record from the remote address book. As yet another alternative, operation 300 may include providing a move command to move the record from one of the address books to the deleted file repository in which the move command results in removal of the record from the one of the address books. In some embodiments, an additional optional operation may include enabling restoration of the record to each of the address books via synchronization between respective devices associated with each of the address books subsequent to recovery of the record at one of the respective devices at operation 330. In some cases, operation 340 including providing an instruction to delete the record from the deleted file repository in response to recovery of the record at the device may alternatively or additionally be included in the method.

In some embodiments, certain ones of the operations above may be modified or further amplified as described below. In this regard, for example, receiving the instruction may include receiving the instruction responsive to a user request to restore the record. In some cases, the recovery of operation 320 may be provided via web access to options for enabling the user to perform restoration of the record.

In an exemplary embodiment, an apparatus for performing the method of FIG. 6 above may comprise one or more processors (e.g., the processor 70) configured to perform some or each of the operations (300-340) described above based on hard coded instructions or based on execution of computer program code stored in a memory (or multiple memories). Thus, the processor may, for example, be configured to perform the operations (300-340) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 300-340 may comprise, for example, the processor 70, respective ones of the synchronizer 78, the restoration agent 80, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising at least one processor and at least one memory including computer program code, the at least one memory and the computer program code configured to, with the at least one processor, cause the apparatus to:
receive an instruction to restore a record associated with a contact previously deleted from each of at least two synchronized address books; and
recover the record from a deleted file repository at which the record was stored prior to deletion of the record, the deleted file repository being a memory location different than the address books.

2. The apparatus of claim 1, wherein the at least one memory and the computer program code are further configured to, with the at least one processor, cause the apparatus to enable restoration of the record to each of the address books via synchronization between respective devices associated with each of the address books subsequent to recovery of the record at one of the respective devices.

3. The apparatus of claim 1, wherein receiving the instruction comprises receiving the instruction responsive to a user request to restore the record.

4. The apparatus of claim 1, wherein receiving the instruction occurs subsequent to a deletion of the record via operations comprising:
providing a copy command to copy the record from one of the address books to the deleted file repository; and
providing a delete command to delete the record from the one of the address books.

5. The apparatus of claim 1, wherein receiving the instruction occurs subsequent to a deletion of the record via operations comprising:
deleting the record at a local address book;
providing an instruction to synchronize the local address book with a remote address book in response to which a corresponding record to the deleted record is automatically copied from a remote address book to the deleted file repository; and
providing a delete command to delete the record from the remote address book.

6. The apparatus of claim 1, wherein receiving the instruction occurs subsequent to a deletion of the record via providing a move command to move the record from one of the address books to the deleted file repository, the move command resulting in removal of the record from the one of the address books.

7. The apparatus of claim 1, wherein the at least one memory and the computer program code are further configured to, with the at least one processor, cause the apparatus to provide an instruction to delete the record from the deleted file repository in response to recovery of the record at the device.

8. The apparatus of claim 1, wherein the deleted file repository is located at a server device.

9. The apparatus of claim 1, wherein the deleted file repository is located at a client device.

10. The apparatus of any preceding claim 1, wherein the at least one memory and the computer program code are further configured to, with the at least one processor, cause the apparatus to provide web access to options for enabling the user to perform restoration of the record.

11. A method comprising:
receiving an instruction to restore a record associated with a contact previously deleted from each of at least two synchronized address books; and
recovering, at a device associated with one of the address books, the record from a deleted file repository at which the record was stored prior to deletion of the record, the deleted file repository being a memory location different than the address books.

12. The method of claim 11, further comprising enabling restoration of the record to each of the address books via synchronization between respective devices associated with each of the address books subsequent to recovery of the record at one of the respective devices.

13. The method of claim 11, wherein receiving the instruction comprises receiving the instruction responsive to a user request to restore the record.

14. The method of claim 11, wherein receiving the instruction occurs subsequent to a deletion of the record via operations comprising:
providing a copy command to copy the record from one of the address books to the deleted file repository; and
providing a delete command to delete the record from the one of the address books.

15. The method of claim 11, wherein receiving the instruction occurs subsequent to a deletion of the record via providing a move command to move the record from one of the address books to the deleted file repository, the move command resulting in removal of the record from the one of the address books.

16. A computer program product comprising at least one computer-readable storage medium having computer-executable program code portions stored therein, the computer-executable program code portions comprising:
program code instructions for receiving an instruction to restore a record associated with a contact previously deleted from each of at least two synchronized address books; and
program code instructions for recovering, at a device associated with one of the address books, the record from a deleted file repository at which the record was stored prior to deletion of the record, the deleted file repository being a memory location different than the address books.

17. The computer program product of claim 16, further comprising program code instructions for enabling restoration of the record to each of the address books via synchronization between respective devices associated with each of the address books subsequent to recovery of the record at one of the respective devices.

18. The computer program product of claim 16, wherein program code instructions for receiving the instruction include instructions for receiving the instruction responsive to a user request to restore the record.

19. The computer program product of claim 16, wherein program code instructions for receiving the instruction occurs subsequent to a deletion of the record via operations include instructions for:
providing a copy command to copy the record from one of the address books to the deleted file repository; and
providing a delete command to delete the record from the one of the address books.

20. The computer program product of claim 16, wherein program code instructions for receiving the instruction are executed subsequent to instructions for deletion of the record via providing a move command to move the record from one of the address books to the deleted file repository, the move command resulting in removal of the record from the one of the address books.
